(19) United States
(12) Patent Application Publication
(10) Pub. No.: US 2025/0378158 A1
(43) Pub. Date: Dec. 11, 2025

(54) SYSTEMS AND METHODS FOR DETECTION OF ADVANCED PERSISTENT THREATS IN AN INFORMATION NETWORK

(71) Applicant: BINALYZE YAZILIM A.S., Cankaya/Ankara (TR)

(72) Inventors: Emre TINAZTEPE, Tallinn (EE); Ahmet SALIH, Istanbul (TR)

(21) Appl. No.: 18/876,946

(22) PCT Filed: Jun. 24, 2022
(86) PCT No.: PCT/TR2022/050653

§ 371 Date: Dec. 19, 2024

(51) Int. Cl. G06F 21/55

(52) U.S. Cl. CPC G06F 21/55

(57) ABSTRACT

Disclosed invention proposes a method of differential analysis of assets in an information system network which compares different states of at least one asset in its network, with one of said states corresponding to a certain point in time, whereas at least one other of said states at least corresponding to one other certain point in time. Disclosed invention also proposes a distance metric between said at least one state and at least one other state of an asset in the information system network, as well as a method to propose a method of determining presence of advanced persistent threats (APTs) or internal investigations in an information system network based on the qualitative and quantitative properties of 15 said distance metric.

### TECHNICAL FIELD OF THE PRESENT INVENTION

The invention presented hereby relates generally to security and digital forensics arrangements for networks comprising multiple assets. The invention more specifically refers to arrangements whereby intrustions to a system are detected over a long-term time frame, such as advanced persistent threats, important changes that may provide advantage to an attacker or an employee with malicious intent, such as an insider.

### PRIOR ART/BACKGROUND OF THE PRESENT INVENTION

Advanced persistent threats (APTs) are malicious entities/actors that, over an extended period of time, gain unauthorized access to a computer network and maintain presence in an undetected manner. Such actors may pose as such threats for a variety of purposes in a wide array of sectors, namely government, legal, financial, telecommunications, defense services with the intent of disruption or long-term espionage. Such a time frame wherein APTs maintain presence in a system is called a “dwell-time”, which can range from at least a couple of months to a year when undetected.

Carried out generally by political and/or economic motivations, such advanced persistent threat attacks follow a general process of what is called a kill chain. Developed by Lockheed-Martin, kill chain outlines seven phases of a cyberattack through which a malicious entity gains access to a compromised computer network, establishes presence, deploys certain tools for exploitation and moves forward with data exfiltration. As a more recent update, a Unified Kill Chain (UKC) model was proposed by combining MITRE's ATT&CK framework and the kill-chain, which postulates eighteen unique attack phases that can occur in advanced types of cyber threats. A noteworthy aspect that makes these types of threats persistent is their ability of lateral movement, during which they oversee control of the infrastructure elements constituting the target computer network as a whole, at times switching assets and bolstering the extent of compromise while remaining undetected by conventional, monitoring-based cybersecurity measures.

A document known in the art, EP 3462698 B1, discloses systems and methods for cloud detection, investigation and elimination of targeted attacks. In one example, the system comprises a computer protection module configured to: gather information on an object in a computer in a network; and save a security notification with the object in an object database in the network; and a module for protection against targeted attacks configured to: search for the object in a threat database in the network; add one or more tags to the object when the object is found in the threat database and adding a correspondence between a record in the object database and the threat database; and determine that a computer attack has occurred when the one or more tags correspond to signatures in a database of computer attacks.

According to the teaching of U.S. Pat. No. 10,885,212 B2, an endpoint has a tamper protection cache that identifies protected computing objects, along with a process cache that stores information for processes executing on the endpoint. By securing the tamper protection cache with reference to a trust authority external to the endpoint, or the operating system for the endpoint, computing objects listed in the tamper protection cache can be protected against unauthorized modifications from malware or other malicious or otherwise potentially unsafe code.

U.S. Pat. No. 10,320,814 B2 discloses a system for detecting an advanced persistent threat (APT) attack on a private computer network includes hosts computers that receive network traffic and process the network traffic to identify an access event that indicates access to a critical asset of an organization that owns or maintains the private computer network. The critical asset may be a computer that stores confidential data of the organization. Access events may be stored in an event log as event data. Access events indicated in the event log may be correlated using a set of alert rules to identify an APT attack.

EP 3779746 A1 discloses a forensic investigation system for conducting distributed digital forensic processing, the system including: one or more agent computing devices including: at least one data-collecting agent device operable to collect digital forensic data; and at least one processing agent device operable to conduct at least a portion of the distributed digital forensic processing on the digital forensic data; a central computing device for managing the operation of the one or more agent computing devices for conducting the distributed digital forensic workflow, the central computing device operable to communicate with the one or more agent computing devices via at least one data communication network; and a data storage device for storing the digital forensic data collected by the at least one data-collecting agent device.

Teaching of EP 3944111 A1 includes a method of generating a minimal forensic image of a target dataset to reduce upload demand. The method includes storing a set of criteria in an investigator device, wherein the set of criteria determines target data files of the target dataset which are to be included in the minimal forensic image, and wherein the set of criteria includes a plurality of file types and at least a first upload format for each file type in the plurality of file types, locating the target data files of the plurality of file types in the target dataset using the set of criteria, storing a representation of each target data file in the minimal forensic image in an MFI upload format determined according to the set of criteria, and transferring the minimal forensic image to a cloud server.

### Objects of the Present Invention

Primary object of the disclosed invention is to present a method of differential analysis of assets in an information system network.

Another object of the disclosed invention is to present a method of differential analysis of assets in an information system network which compares different states of at least one asset in its network.

Another object of the disclosed invention is to present a method of differential analysis of assets in an information system network which compares different states of at least one asset in its network, with one of said states at least corresponding to a certain point in time, whereas at least one other of said states at least corresponding to one other certain point in time.

Yet another object of the disclosed invention is to propose a distance metric between said at least one state and at least one other state of an asset in the information system network.

Yet another object of the disclosed invention is to propose a method of determining presence of advanced persistent threats (APTs) in an information system network based on the qualitative and quantitative properties of said distance metric or the actions performed by an employee such as the case with an insider investigation.

### SUMMARY OF THE PRESENT INVENTION

Disclosed invention proposes a system and method for differential analysis of information assets, suitable for an information system network. Said system may comprise a set of assets each able to display different characteristics, such as criticality, significance and type, based on their location and importance for said information system network.

Disclosed invention is presented as a solution to the problem of advanced persistent threats or insider threats that cannot be addressed properly, timely or effectively using conventional, monitoring-based solutions known in the art. To this end, a long-term differential analysis tool is proposed that treats the persistent nature of the APTs in a manner not as a security event needing to be managed, but a diffuse process rendered detectable by comparing different states (i.e. forensic states) of any asset found in the information system network. These assets may be a mobile device, a personal computer, a workstation, a virtual machine, a cloud service or a cloud platform and may encompass multiple forensic states of a single state or single forensic states of multiple assets.

Further, the method of differential analysis will be based on multiple snapshots that are taken from a single asset at different points in time. According to another embodiment, the method may be based on individual snapshots that are taken from multiple assets. Said forensic snaphsots comprise either pre-defined (e.g. by a “golden image” for initializing an asset's operational condition) or user-defined properties of an asset, which may be represented in binary or text format, as well as CSV, JSON, txt or log file format. The method allows for determining what is added, changed, deleted or removed in the assets to allow for penetration, persistence or decreasing the security level of an otherwise secure system, based on difference between said forensic images.

Disclosed system and method is advantageous next to the techniques known in the art in that it specifically addresses the problem of advanced persistent threats (APTs) or insider threat investigations being able to maintain access and presence under low detectability. Via leveraging aforementioned concept of forensic snapshots, disclosed inventon is able to surpass monitoring-based solutions in the art that are geared towards security events, rather than processes that encompass a longer period as theorized with unified kill chain.

### BRIEF DESCRIPTION OF THE FIGURES OF THE PRESENT INVENTION

Accompanying figures are given solely for the purpose of exemplifying a system and method of differential analysis and diagnosis for APTs, whose advantages over prior art were outlined above and will be explained in brief hereinafter.

The figures are not meant to delimit the scope of protection as identified in the claims nor should they be referred to alone in an effort to interpret the scope identified in said claims without recourse to the technical disclosure in the description of the present invention.

FIG. 1 illustrates a flow diagram of the method of differential analysis as described in the present invention.

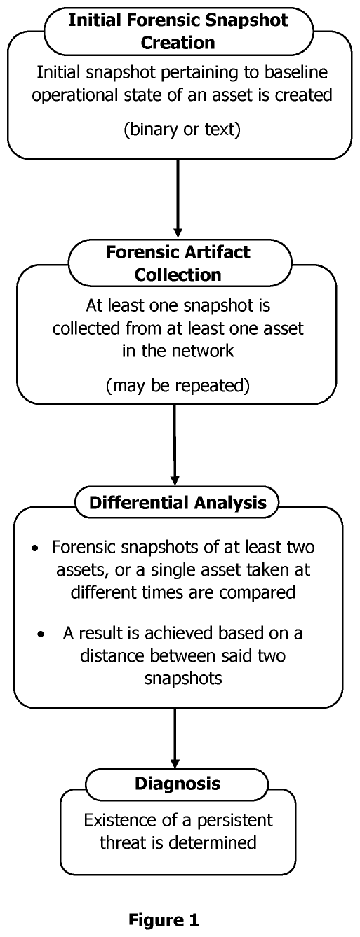

### DETAILED DESCRIPTION OF THE PRESENT INVENTION

Following is the inventive subject matter of the present disclosure. Embodiments are displayed to represent an example and not to limit the borders of the invention. Some well-known specific details of the embodiments are not necessarily shown.

According to an embodiment of the disclosed invention, an information network is provided. Said information system network comprises different assets, such as individual workstations in a network in a business or information processing and sharing setting. Such an asset, according to an embodiment, may be a computer comprising at least one hard drive, at least one non-transitory computer readable medium, such as a random access memory (RAM).

Said at least one asset, according to different embodiments, may be initialized based on an initial state deemed functional by the specific requirements of the information system network. Such an initial state may be generated using what is called a golden image, pertaining to a group of settings for an asset joining said network. An example of such golden images may be a compact disc (CD) contain setup settings of a personal computer given to a new employee in an enterprise, itself customizable based on the clearance level of the employee and the privileges associated with the asset used.

Presence of a malware (e.g. a ransomware, trojan, spyware) in an asset may be, depending on the properties of said asset in a given point in time, associated with a state, more specifically a forensic state. Such forensic states may reflect the extent to which said asset is compromised, deducible from the differential distance between the actual condition of the compromised asset and its respective golden image. Such a differential distance pertains to what is added, modified, removed or deleted from the forensic state considered significant and critical by the requirements and needs of said information system network's security level.

According to different embodiments, different types of assets have different levels of significance and criticality determined by the administrative as well as functional needs in an information network. For example, an asset comprising information pertaining to financial transactions between different parties, authentication settings and personal information may be highly critical, whereas standard workstations for entry-level personnel may be of low criticality. In some embodiments, critical assets may need to be continuously assessed for compromise. In vairous other embodiments, sub-critical assets, i.e. assets that are of secondary importance are also continuously assessed.

According to various embodiments of the disclosed invention, a method of differential analysis for cyber incidents is proposed. Said method is also utilizable for investigation against specific and long-term cyber incidents such as advanced persistent threats in an information system network.

Said information system networm may comprise at least multiple assets such as a mobile device, a computer, a virtual machine, a cloud service, or a cloud platform.

In various embodiments, said method of differential analysis is based on multiple snapshots that are taken from a single asset at different points in time. According to another embodiment, the method may be based on individual snapshots that are taken from multiple assets. Said forensic snaphsots comprise either pre-defined (e.g. by a “golden image” for initializing an asset's operational condition) or user-defined properties of an asset, which may be represented in binary or text format, as well as CSV, JSON, txt or log file format. The method allows for determining what is added, changed, deleted or removed in the assets to allow for penetration, persistence or decreasing the security level of an otherwise secure system, based on difference between said forensic images.

According to at least one embodiment of the disclosed invention, said method comprises a step of initial forensic snapshot creation. Said step of initial forensic snapshot creation pertains to creation and storage of a certain initial snapshot. Said forensic snapshot contains information regarding the baseline operational state of an asset, which may be based on predetermined characteristics of the device or asset in question. Properties, clearances and operational characteristics of that specific asset or its use case can form the basis of said forensic snapshot. In several embodiments, said snapshot may be selectable from a group of binary or text formats including, but not limited to, CSV, JSON, plaintext, or log files.

In various aspects of the present disclosure, said forensic snapshot is configured to reflect the forensic state of an asset in said information system network. Said forensic state may be a baseline operational state created and initialized on a device with utility of a golden image, or it may alternatively be a snapshot collected at a certain point in time.

According to at least one embodiment of the disclosed invention, said method comprises a step of forensic artifact(s) collection. In said step of forensic artifact collection, at least one other forensic snapshot based on a set of predefined or user-defined parameters related to the operational and persistent state of at least one asset is collected. In an embodiment, said asset the forensic snapshot is extracted from may be the identical asset as in the initial forensic snapshot creation step, or may be a different asset of a comparatively similar role in the information system network.

According to at least one embodiment of the disclosed invention, said method comprises a step of differential analysis. In said differential analysis step, said at least a set of predefined parameters related to the operational and persistent state of at least one asset collected in the previous step (i.e. the forensic artifact(s) collection step) is differentially compared to that of a said certain initial forensic snapshot, and a result is achieved based on a distance between said two snapshots.

According to at least one embodiment of the disclosed invention, said method comprises a step of diagnosis. In said diagnosis step, the existence of a persistent threat is determined based on reducing the evidence to look at, prioritizing threats based on their relevance.

According to at least one embodiment of the disclosed invention, said method comprises a step of evidence reduction, wherein a set of parameters present in the initial snapshot and the non-initial snapshot are prioritized based on a user-defined measure of relevance. Said prioritization may also be based on a set of rules.

According to at least one embodiment of the disclosed invention, said method comprises a step of change display, wherein what is shared, unique, changed, added, or removed from the initial snapshot to the non-initial snapshot represented by said distance in the differential analysis step are displayed to a user.

In various embodiments, what is disclosed is an information system network comprising at least multiple assets. Said network also comprises at least one asses comprising a storage media such as a memory and a processor configured to implement at least a set of security-related properties and actions stored in said storage medium. According to an embodiment, said processor is configured to collect a forensic snapshot comprising at least a set of predefined or user-defined parameters related to the operational state of at least one asset at the beginning and the end of a predetermined time interval. According to an embodiment, said processor may be further configured to differentially compare said images and run an analysis wherein a measure of distance between two operational states is determined, said operational states being extractable from said forensic snapshots/images.

In an embodiment, said processor comprises a forensic image collection submodule which is configured to collect at least two forensic snapshots comprising at least a set of predefined or user-defined parameters related to the operational state of at least one end device at the beginning and the end of a predetermined or user-defined time interval. In an embodiment said processor may further comprise a comparison submodule configured to differentially compare said at least two forensic snapshots and run an analysis wherein a measure of distance between two operational states is determined. In another embodiment, said processor further comprises an evaluation submodule configured to determine a level of threat based on the differential comparison result output of said comparison module, said level of threat being at least a category selectable from said security-related properties stored in said storage medium.

According to various embodiments, said system may also comprise an endpoint agent executable in at least one type of asset. Said endpoint agent may be tasked with collecting forensic data from at least one other asset in said information system network. Said endpoint agent may also be configured to provide a comprehensive interpreted programming language allowing a user to perform inspections of all system areas, such as the file system, the registry, the memory, the system and event logs, kernel objects and other sub-components of the information network.

Said endpoint agent may also be configured to record and collect several types of events such as process launches, network activity, persistence events, thread injections and authentication data. Said artifacts detectable in a forensic image of an asset, comparable with a certain other forensic image or a golden image of said asset, provides the data required by the processing means to detect malicious behavior and activity.

According to various embodiments, said endpoint agent configured to record and collect several types of events is also configured to detect at least multiple types of actions associated by said several types of events. As an example, a change to a type of golden image associated with a type of asset may be categorized with authentication breaches, registry edits, disk writes, copy actions, exfiltrations and the like. Such categorizations may be predetermined, or user-determined, and may be based on rules. Said rules can enable endpoint agent monitors and other authorized agents to categorize different actions such as allowable benevolent actions, unallowable malicious actions, and unknown events. For example, an event such as a security update to a member in the information system/network may be identified as an allowable benevolent event, whereas previously-identified, known malware can be identified as a malicious event that is not allowable. Such benevolent and malicious acts may be handled by the endpoint agent, either by allowing or disallowing the activity, or even using established means such as quarantining. On the other hand, when an unknown event occurs, the endpoint agent may be unable to act on said event based on preexisting rules. Said unknown events may be sent to at least one authorized agent to be flagged for further analysis. Said authorized agent may be able to correlate unknown events with other events identified by other endpoints to aid in understanding the nature of the event. In particular embodiments, the event data and the correlations with other events can be presented to an analyst for further study. Once the nature of the event has been established, updated rules can be propagated to the endpoints so that similar events can be handled appropriately via endpoint agents.

It should be understood that other embodiments and examples may provide similar functions and similar results with the included embodiments of the present invention. All such cases are in the domain of the present disclosure.

1. A method of differential analysis and investigation against cyber incidents such as advanced persistent threats in an information system network comprising at least multiple assets such as a mobile device, a computer, a virtual machine, a cloud service, or a cloud platform, the method comprising:
initial forensic snapshot creation, wherein a certain initial snapshot pertaining to the baseline operational state of an asset is created based on predetermined characteristics of the device that may be based on properties of that specific asset or its use case, said snapshot being selectable from a group of binary or text formats including, but not limited to, CSV, JSON, plaintext, or log file,
forensic artifacts collection, wherein at least one other forensic non-initial snapshot based on a set of predefined or user-defined parameters related to the operational and persistent state of at least one asset is collected,
differential analysis, wherein said set of predefined parameters related to the operational and persistent state of at least one asset collected step is differentially compared to that of a said certain initial snapshot, and a result is achieved based on a distance between said two snapshots,
diagnosis, wherein at the end of the differential analysis, the existence of a persistent threat is determined based on evidence reduction, threat prioritization based on relevance, and displaying what is shared, unique, changed, added, or removed from the initial snapshot to the non-initial snapshot represented by said distance in the differential analysis.

2. method of differential analysis and investigation against cyber incidents as set forth in claim 1 further comprising evidence reduction, wherein a set of parameters present in the initial snapshot and the non-initial snapshot are prioritized based on a user-defined measure of relevance.

3. The method of differential analysis and investigation against cyber incidents as set forth in claim 1 further comprising threat prioritization, wherein a level of threat is ascribed to at least two of said multiple assets, based on the distance between their respective initial images and non-initial images.

4. An information system network comprising at least multiple assets and at least one asset comprising a storage medium such as a memory and a processor configured to implement at least a set of security-related properties stored in said storage medium wherein,
said processor is configured to collect a forensic snapshot comprising at least a set of predefined or user-defined parameters related to the operational state of at least one end device at the beginning and the end of a predetermined time interval; and,
said processor is further configured to differentially compare said images and run an analysis wherein a measure of distance between two operational states is determined.

5. The information system network as set forth in claim 4 wherein,
said processor further comprises a forensic image collection submodule configured to collect at least two forensic snapshots comprising at least a set of predefined or user-defined parameters related to the operational state of at least one end device at a beginning and an end of a predetermined or user-defined time interval,
said processor further comprises a comparison submodule configured to differentially compare said at least two forensic snapshots and run an analysis wherein a measure of distance between two operational states is determined, and
said processor further comprises an evaluation submodule configured to determine a level of threat based on the differential comparison result output of said comparison module, said level of threat being at least a category selectable from said security-related properties stored in said storage medium.

6. The method of differential analysis and investigation against cyber incidents as set forth in claim 2 further comprising threat prioritization, wherein a level of threat is ascribed to at least two of said multiple assets, based on the distance between their respective initial images and non-initial images.
